(19) United States
(12) Patent Application Publication
(10) Pub. No.: US 2001/0055243 A1
(43) Pub. Date: Dec. 27, 2001

(54) Apparatus for locating an individual

(76) Inventor: Dona Haywood, Chicago, IL (US)

Correspondence Address: Matthew J. Peirce, Esq., 1550 Starlight Canyon Avenue, Las Vegas, NV, 89123, US

(21) Appl. No.: 09/887,785

(22) Filed: Jun. 22, 2001

Related U.S. Application Data
(60) Provisional application No. 60/213,434, filed on Jun. 22, 2000.

(51) Int. Cl. G04B 47/00; G04C 11/02

(52) U.S. Cl. 368/10; 368/47

(57) ABSTRACT

A new and improved apparatus is disclosed to assist users in locating a lost child or person. The present invention would comprise a watch which would have an internal homing device. The homing device would be activated by remote commands sent by police or other adults. The remote commands would be relayed to the homing device on the watch via a satellite. Once the homing device would be activated, the homing device would send out signals that would be picked up by at least three satellites, allowing the present location of a user of the watch of the present invention to be pinpointed. The present invention would also include a “panic button” which could be used by a wearer of the watch himself to activate the homing device on the watch of the present invention.

### I. BACKGROUND OF THE INVENTION

The present invention concerns that of a new and improved apparatus to assist users in locating a lost child or person.

### II. DESCRIPTION OF THE PRIOR ART

U.S. Pat. No. 5,617,074, issued to White, discloses a child finder which consists of a transmitter which is concealingly attachable to a child's body and sends a signal to a conventional receiver so that the child's location can be continually monitored.

U.S. Pat. No. 5,574,433, issued to Bahcall, discloses a personal security alarm which is combined with a wristwatch to be readily accessible on a user's wrist in an emergency situation.

U.S. Pat. No. 4,591,836, issued to Feigenblatt, Jr., discloses a wrist watch alarm which has a watch and a band, and further includes an audio transducer for producing an audio signal.

U.S. Pat. No. 4,063,410, issued to Welling, discloses a digital wristwatch which includes a transmitter therein for selective activation of a remote electronic circuit by the wearer of the wristwatch.

### III. SUMMARY OF THE INVENTION

The present invention concerns that of a new and improved apparatus to assist users in locating a lost child or person. The present invention would comprise a watch which would have an internal homing device. The homing device would be activated by remote commands sent by police or other adults. The remote commands would be relayed to the homing device on the watch via a satellite. Once the homing device would be activated, the homing device would send out signals that would be picked up by at least three satellites, allowing the present location of a user of the watch of the present invention to be pinpointed. The present invention would also include a “panic button” which could be used by a wearer of the watch himself to activate the homing device on the watch of the present invention.

There has thus been outlined, rather broadly, the more important features of an individual locater apparatus in order that the detailed description thereof that follows may be better understood and in order that the present contribution to the art may be better appreciated. There are, of course, additional features of the individual locater apparatus that will be described hereinafter and which will form the subject matter of the claims appended hereto.

In this respect, before explaining at least one embodiment of the individual locater apparatus in detail, it is to be understood that the individual locater apparatus is not limited in its application to the details of construction and to the arrangements of the components set forth in the following description or illustrated in the drawings. The individual locater apparatus is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present individual locater apparatus. It is important, therefore, that the claims be regarded as including such equivalent constructions insofar as they do not depart from the spirit and scope of the present invention.

It is therefore an object of the present invention to provide an individual locater apparatus which has all of the advantages of the prior art and none of the disadvantages.

It is another object of the present invention to provide an individual locater apparatus which may be easily and efficiently manufactured and marketed.

It is another object of the present invention to provide an individual locater apparatus which is of durable and reliable construction.

It is yet another object of the present invention to provide an individual locater apparatus which is economically affordable and available for relevant purchasing government entities.

Other objects, features and advantages of the present invention will become more readily apparent from the following detailed description of the preferred embodiment when considered with the attached drawings and appended claims.

### IV. BRIEF DESCRIPTION OF THE DRAWINGS

FIG. 1 shows a top view of a watch of the present invention.

FIG. 2 shows a perspective representative view of a satellite that could be used with the present invention to help relay signals from the homing device.

### V. DESCRIPTION OF THE PREFERRED EMBODIMENT

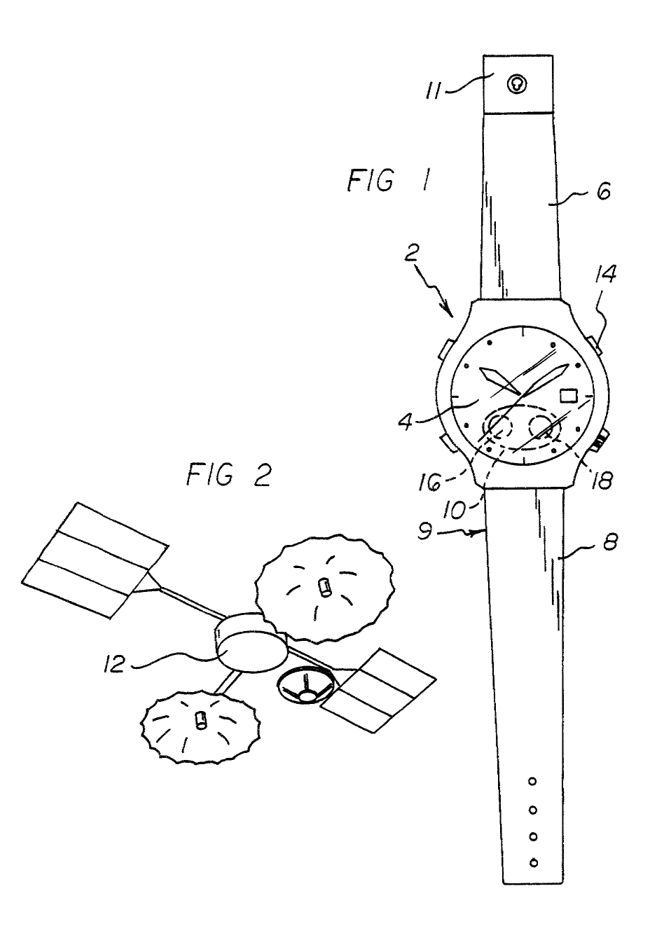

FIG. 1 shows a top view of a watch 2 of the present invention. Watch 2 has a top face 4 and wrist straps 6 and 8 which would allow watch 2 to be fastened to a user's wrist. Wrist straps 6 and 8 together would comprise wristband 9.

Watch 2 also has an internal homing device 10. Homing device 10 would be activated by remote radio wave commands sent by police or other adults. The remote commands would be relayed to homing device 10 on watch 2 via a satellite 12. Once homing device 10 would be activated, homing device 10 would send out signals that would be picked up by at least three satellites, allowing the present location of a user of the watch 2 of the present invention to be pinpointed. The present invention would also include a panic button 14, which could be used by a wearer of watch 2 to activate the homing device 10 on the watch of the present invention.

Wristband 9 would be designed in the same style as a regular wristband, with wristband 9 including a plurality of adjustable holes. However, wristband 9 of the present invention would include a locking device 11, which could be locked in place by an adult, guardian, or other responsible person. Locking device 11 would be preferably unlocked by the use of a key and would help to prevent children from unlocking and removing the present invention themselves. In addition, wristband 9 would be fabricated from material that would be very hard to cut. When in use, wristband 9 would be closely fitted to the wrist of a wearer.

Homing device 10 would include receiving means 16 and transmitting means 18, which would allow homing device 10 to receive and transmit radio waves when appropriate. The radio waves that receiving means 16 and transmitting means 18 would be designed to use would be specific to each particular 2 watch used with the present invention.

FIG. 2 shows a perspective representative view of satellite 12 that could be used with the present invention to help relay signals from homing device 10. Normally, it would be necessary for more than one satellite to be activated by radio waves sent by police or other authorities to ensure that homing device 10 on watch 2 for a particular user would be activated. In addition, it would take at least three satellites, using current GPS technology, to ensure that a user's location would be properly pinpointed.

Once the homing device would be activated, it would be in constant communication with the various satellites and the police or other authorities, ensuring that a user wearing the present invention could easily be located by people on the ground. The present invention would assist greatly when a child or person has been inappropriately taken by an unauthorized user, because the abductor may not know he is being homed in on or accurately tracked by the present invention.

What I claim as my invention is:

1. An apparatus for locating an individual comprising:
(a) a watch including a pair of straps, the watch having a top edge, a bottom edge and a pair of side edges, a first strap and a second strap, the first strap and the second strap each having two ends, a first end and a second end, the first end of the first strap being connected to the top edge of the watch, the first end of the second strap being connected to the bottom edge of the watch, the second end of the first strap designed to be removably connected to the second end of the second strap,
(b) an internal homing device, the internal homing device including a receiver and a transmitter, the receiver designed to receive and recognize radio waves of a specific or narrow band of wavelengths, the transmitter designed to transmit radio waves of a specific or narrow band of wavelengths that would be the same as that for the receiver within the watch,
(c) whereby the receiver, upon receiving and recognizing a signal transmitted from a remote location, would activated the transmitter within the homing device, whereby the transmitter would then transmit signals to a plurality of GPS satellites, whereby the location of an individual wearing the watch could be determined by another person or entity at a distant location.

2. An apparatus for locating an individual according to claim 1 wherein the watch would further include a panic button, the panic button being attached to a side edge of the watch, the panic button designed to activate the transmitter of the homing device of the watch when pressed.

3. An apparatus for locating an individual according to claim 2 wherein the first strap and the second strap would be fabricated from a material that is difficult to cut or break.

4. An apparatus for locating an individual according to claim 2 wherein the apparatus would further comprise a locking device, the locking device designed to removably attach the second end of the first strap to the second end of the second strap, the locking device capable of being locked and unlocked to prevent removal by an individual wearing the apparatus.
